(19) United States
(12) Patent Application Publication
(10) Pub. No.: US 2025/0135765 A1
(43) Pub. Date: May 1, 2025

(54) REINFORCED CONDUIT AND METHOD OF FORMING

(71) Applicant: FLEXFAB LLC, Hastings, MI (US)

(72) Inventor: Parker J. Haffey, Grand Rapids, MI (US)

(73) Assignee: FLEXFAB LLC, Hastings, MI (US)

(21) Appl. No.: 18/923,913

(22) Filed: Oct. 23, 2024

Related U.S. Application Data
(60) Provisional application No. 63/593,076, filed on Oct. 25, 2023.

(51) Int. Cl. B32B 38/00; B32B 1/08; B32B 5/02; B32B 5/18; B32B 5/24; B32B 37/00; B32B 37/10; B32B 37/20; F16L 9/128

(52) U.S. Cl. CPC B32B 38/0036; B32B 1/08; B32B 5/02; B32B 5/18; B32B 5/245; B32B 37/0038; B32B 37/10; B32B 37/203; F16L 9/128; B32B 2250/02; B32B 2260/021; B32B 2260/046; B32B 2262/0269; B32B 2262/106; B32B 2266/0235; B32B 2305/022; B32B 2305/10; B32B 2313/04; B32B 2327/12; B32B 2377/00; B32B 2597/00

(57) ABSTRACT

A duct and method of forming the duct, can include a foam duct for moving fluids or gases within a system. A reinforcement structure can be applied to the duct, formed onto the duct, or formed with the duct in order to reduce, minimize, mitigate, or eliminate thermal expansion or contraction of the duct. The method can include dry or wet bonding, using a solvent solution with similar material from the duct in order to facilitate bonding of the reinforcement material to the duct.

### CROSS-REFERENCE TO RELATED APPLICATIONS

This application claims the benefit of U.S. Provisional Patent Application No. 63/593,076, filed on Oct. 25, 2023, the entirety of which is incorporated herein by reference.

### TECHNICAL FIELD

The present subject matter relates generally to a fluid conduit system and method of forming such a fluid conduit for the fluid conduit system or the fluid conduit itself, and more specifically, to a fluid conduits system and method of forming for controlling thermal expansion.

### BACKGROUND

Conduits, tubes, pipes, and other structures are utilized in moving fluids and gases within a system, or from one system to another, as well as for heat exchange or other functions. Large conduits, tubes, pipes, or other structures, or those experiencing large variations in temperature can result in thermal expansion or contraction of the conduits, tubes, pipes, or other structures, which can vary the geometries of parts of the system.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of a duct having a reinforcement structure, in accordance with aspects of the present disclosure.

FIG. 2 is a perspective view of a duct having a reinforcement structure system and end caps, in accordance with aspects of the present disclosure.

FIG. 3 is a perspective view of a duct having a set of reinforcement structures extending beneath opposing cuffs, in accordance with aspects of the present disclosure.

FIG. 4 is a perspective view of a duct having a reinforcement structure and a spiral seam, in accordance with aspects of the present disclosure.

FIG. 5 is a schematic, cross-sectional view of a welding system for coupling a reinforcement structure to a conduit, in accordance with aspects of the present disclosure.

FIG. 6 is a flow chart depicting a method of forming a duct, in accordance with aspects of the present disclosure.

FIG. 7 is a flow chart depicting another method of forming a duct, in accordance with aspects of the present disclosure.

### DETAILED DESCRIPTION

Conduits or ducts for moving fluid or gas can experience thermal expansion due to temperature change of the conduit. Such a temperature change can be the result of the materials moved within the conduit, or the exterior environment heating or cooling the conduit, or both, in non-limiting examples. The degree to which such a conduit expands or contracts can be represented by its coefficient of thermal expansion. Foam ducts, specifically, are susceptible to expansion or contraction due to the temperature change, and specifically, large or long ducts, or those having a large diameter, or combinations thereof, therefore requiring greater care within an operational environment to account for such expansion or contraction. Specifically, the greater care required can result in a restriction of use-cases for certain conduits, such as foam ducts, as implementation may be limited by available space for thermal expansion or contraction, or where temperature variation is limited such that any anticipated expansion or contraction is within an expected temperature range. In situations where large ducts are utilized, or where large temperature changes are seen, unmitigated thermal expansion can lead to failure of the ducts, or failure of the other components within such a system, or even the system itself. For example, at the interface of a duct to another duct or end connector, thermal contraction can result in pulling the ducts from their interface connectors. In another example, thermal expansion can result in loosening at the end connectors, and may result in the duct separating from or falling off of the end connector.

A “set” as used herein can be used to represent any number of elements, including only one.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

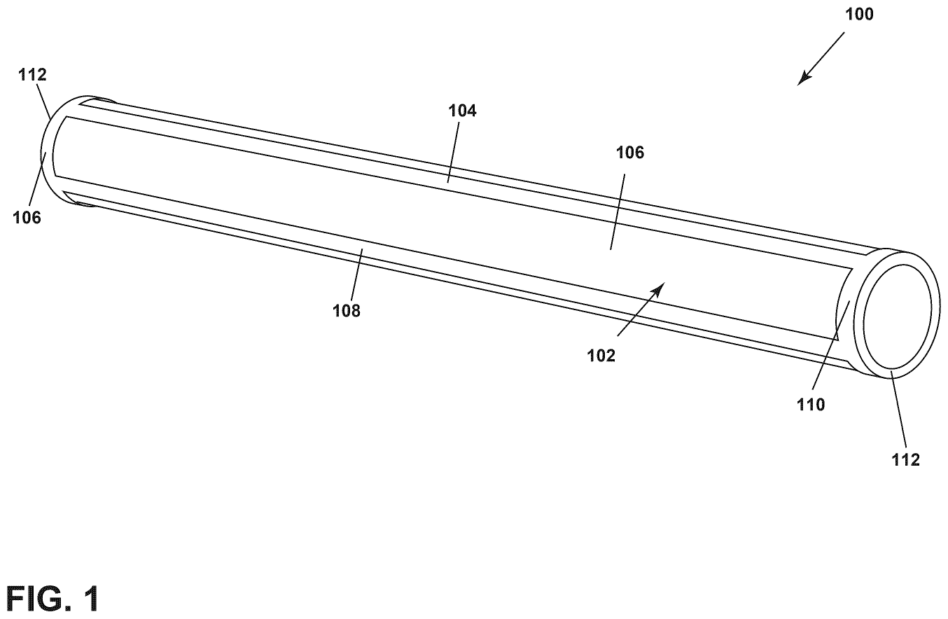

FIG. 1 includes a reinforced duct 100 comprising a duct 102 and a reinforcement structure 104. The duct 102 can be a substantially tubular or cylindrical duct for moving or passing fluids or other items from one location to another. It should be appreciated that while the duct 102 is shown in a cylindrical form herein, the duct 102 can be provided in a pre-rolled or unrolled form, such as a sheet, and can be formed into the cylindrical duct shape either before or after attachment of the reinforcement structure 104. The duct 102 can be made of a foam material or a cross-linked foam material, like a closed-cell and cross-linked PVDF foam (polyvinylidene fluoride foam). In non-limiting examples, the foam material can be a closed-cell or open-cell material, or can be porous. In another non-limiting example, the foam can be a closed-cell PVDF foam (polyvinylidene fluoride foam), while other polymers or thermoplastics are contemplated. Such foam materials are advantageous, as they are lightweight and durable means for low-pressure ducting, and PVDF foam ducts can often provide the lightest-weight option, which can be beneficial in weight-sensitive environments, like aviation. Foams are inherently insulative, which mitigates heat transfer between the material within the duct 102 and the exterior environment, and can be well suited for heat or air conditioning applications. Furthermore, foams are inherently resistant to fungal and microbial development, making the duct 102 well suited for heat or air conditioning applications. Additionally, foams are tough and non-friable, mitigating degradation of the duct 102 over time. Thermoplastics and thermoplastic foams, the duct 102 can be easily manufactured and shaped with heat, and facilitates manufacture while reducing cost. Further still, foams are flammable resistant, and are resistant to smoke release and heat release characteristics, which are beneficial in flame, smoke, or heat sensitive applications, like that of aviation. Alternative materials are contemplated, such as a cross-linked PVDF foam or a cross-linked resin grade PVDF. In another non-limiting example, the foam can have a density between 30-40 kg/m³ (kilograms per cubic meter), while greater or lesser densities are contemplated. In one example, the density can be 38 kg/m³. In another example, the duct 102 can have a length of 120 inches or can be between 3 feet (ft) and 10 ft at ambient temperature, while greater and lesser lengths are contemplated.

In a system using the duct 102, the temperature can vary between −60° F. (degrees Fahrenheit) to 160° F., for example, while a wider range of temperatures is contemplated. Such a temperature of the duct 102 can be a function of the fluid passing through the duct 102 and the temperature of the environment immediately exterior to the duct 102, in non-limiting examples. In a non-limiting example, expansion along the duct 102 can be limited to +/−0.1 inches (in), such as no more than +/−0.1 in expansion or contraction where the duct 102 has the length of 10 ft (120 in) at ambient temperature. That is, the duct 102 has no greater length than 10 ft, 0.1 in and no lesser length than 9 ft, 11.9 in within the particular temperature range experienced by the duct 102. In another non-limiting example, expansion along the duct 102 can be limited to +/−0.2 inches (in) along the length of the duct 102. In another non-limiting example, a thickness for the duct 102, or the wall thereof, can be between 4 mm (millimeters) to 12 mm, while greater or lesser thicknesses are contemplated. It should be understood that the particular sizing and shaping of the duct 102 can be a function of the intended implementation of the duct, the environment in which the duct 102 is utilized, the fluid transferred along the duct 102, or combinations thereof in non-limiting examples. Specifically, the particular length, wall thickness, diameter, and temperature range required by the duct 102 can be defined for the particular implementation or environment in which the duct 102 will be utilized.

The reinforcement structure 104 can be applied onto the duct 102, can be formed onto an exterior surface 106 of the duct 102, or can be formed with or into the duct 102 structure, such the duct 102 and the reinforcement structure 104 define a unitary structure. The reinforcement structure 104 can extend along the longitudinal length of the duct 102, as a set of longitudinal reinforcement structures 108, such as extending fully between opposing ends 112 of the duct 102. The reinforcement structure 104 can include one or more longitudinal reinforcement structures 108, with two longitudinal reinforcement structures 108 visible in FIG. 1. Where two or more longitudinal reinforcement structures 108 are utilized, it is contemplated that the set of longitudinal reinforcement structures 108 are equally spaced circumferentially about the duct 102, while unequal spacing is contemplated. Such an unequal spacing can be specific to the shape of the duct 102, such as where the duct 102 includes a bend or other non-linear shape, where such unequal spacing can be beneficial in mitigating thermal expansion or contraction along such a non-linear shape. For example, such a bend can include a local increase or decrease in spacing in order to mitigate a change in direction of thermal expansion resultant of the bend shape.

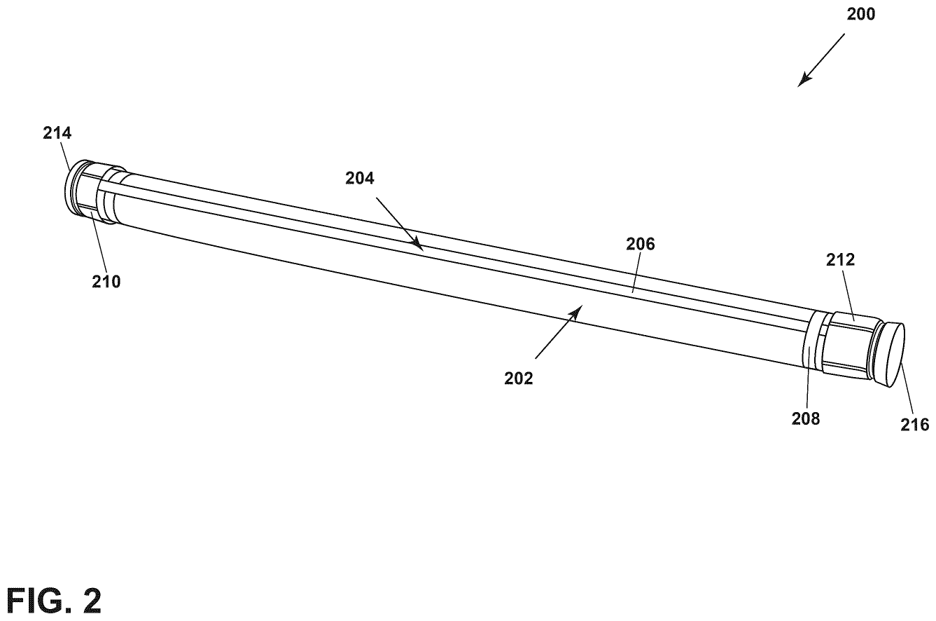

The reinforcement structure 104 can further include a set of circumferential reinforcement structures 110, which extend around the circumference of the duct 102. The set of circumferential reinforcement structures 110 can be integral with the set of longitudinal reinforcement structures 108, in a non-limiting example, defining a reinforcement structure assembly that can be slid over the duct 102 prior to attachment. In another non-limiting example, the set of circumferential reinforcement structures 110 can be separate from the set of longitudinal reinforcement structures 108, or separately attached. The set of circumferential reinforcement structures 110 can be arranged at the opposing ends 112, while spacing from the opposing ends 112 is contemplated (See FIG. 2, for example). In a non-limiting example, the set of circumferential reinforcement structures 110 can be positioned along the length of the duct 102 at a particular spacing, such as having one circumferential reinforcement structure 110 along every 6 in or 12 in of the duct 102, while any spacing interval is contemplated. In yet another non-limiting example, the reinforcement structure 104 can be spiraled around the duct 102. It should be appreciated that the reinforcement structure 104 can be formed of a combination of one or more of the set of longitudinal reinforcement structures 108, one or more circumferential reinforcement structures 110, or both. In one example, the set of longitudinal reinforcement structures 108 and the circumferential reinforcement structures 110 can be integral or unitary, while layering one on top of the other is contemplated.

The reinforcement structure 104 can be a unidirectional tape formed as reinforcement strips, such as a unidirectional tape of fibers, such as carbon fiber or Kevlar fabric in non-limiting examples. Such a unidirectional tape can include fibers immersed in a solid polymer matrix, for example. In one example, the reinforcement structure 104 can be a 12K carbon fiber tow or a 24K carbon fiber tow, and may include a twisted or an untwisted tow or yarn. Alternative materials for the reinforcement structure can be unidirectional carbon fiber, woven carbon fiber, non-woven carbon fiber, or other aramid fiber materials, including meta-aramid materials or para-aramid fabrics. The reinforcement structure 104 can be made of one or more fibers, fabrics, fiber tows, or filaments which are positioned extending along or around the duct 102. In another non-limiting example, the reinforcement structure can be comprised of filament bundles or tows, as well as fabrics composed of a single constituent filament or fabric type. Filament bundles or fabrics in their raw state can be arranged along the duct 102, or can be spooled or wrapped circumferentially about the duct 02 prior to bonding the reinforcement structure 104 to the duct 102. Such a filament, fabric, or other material for the reinforcement structure 104 can include a coefficient of thermal expansion that is less than 10% that of PVDF foams, or having an absolute coefficient of thermal expansion of less than 10 μin/in° F. (microinch per inch per Fahrenheit degree). In one non-limiting example, the filament bundles or fabrics can be those which are not immersed in a polymeric matrix material. In another non-limiting example, the reinforcement structure 104 can be bonded direction to the foam, such as without utilizing an adhesive material to attach the reinforcement structure 104 to the duct 102.

It should be understood that the preferred materials for the reinforcement structure 102, such as carbon fiber or Kevlar fiber, may not or do not form strong chemical bonds with an underlying foam structure of the duct, such as PVDF, and do not bond directly to foam in their virgin state.

Referring to FIG. 2, a reinforced duct 200 is shown having a duct 202 with a reinforcement structure 204 including a set of longitudinal reinforcement structures 206 and a set of circumferential reinforcement structures 208. A first end cap 210 provided at a first end 214 of the duct 202 and a second end cap 212 provided at a second end 216 of the duct 202. The set of longitudinal reinforcement structures 206 can extend between the first end 214 and the second end 216, or can extend between the first end cap 210 and the second end cap 212. The set of circumferential reinforcement structures 208 can be spaced from the first and second end caps 210, 212, the first and second ends 214, 216, or both, or can be at any position along the length of the duct 202. In this way, it should be understood that the set of circumferential reinforcement structures 208 can have any longitudinal position along the duct 202, such as at the first and second ends 214, 216, or spaced therefrom.

In alternative examples, the set of longitudinal reinforcement structures 206 or the set of circumferential reinforcement structures 208 can be offset from the longitudinal extent of the duct 202, or offset from an orthogonal circumferential arrangement for set of circumferential reinforcement structures 208, relative to the longitudinal extend of the duct 202. In such an arrangement, angular orientations of the reinforcement structure 204 are contemplated, such as spiraled along the duct 202 or along portions thereof. Angular arrangements can be desirable to minimize or prevent thermal expansion across non-linear portions of the duct 202, for example.

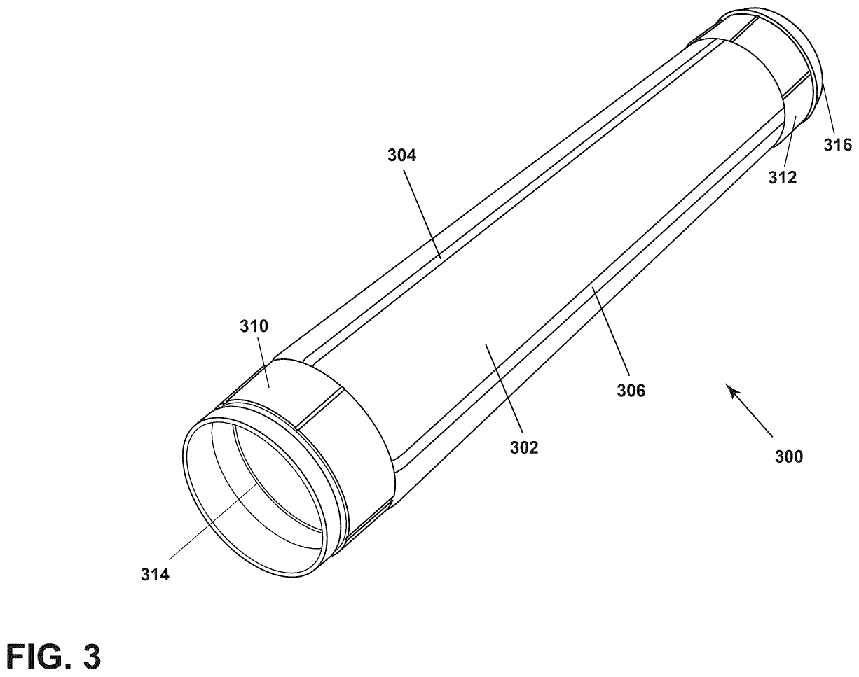

Referring to FIG. 3, a reinforced duct 300 is shown having a duct 302 with a reinforcement structure 304 including a set of longitudinal reinforcement structures 306. A first end cap 310 and a second end cap 312 are provided on a first end 314 and a second end 316 of the duct 302, respectively. The first and second end caps 310, 312 can be arranged exterior of the duct 302 and the set of longitudinal reinforcement structures 306, and can be installed after assembly of the duct 302 and the set of longitudinal reinforcement structures 306, such as to connect the duct 302 to a flow ingress and egress, or to connect multiple ducts in an end-to-end arrangement.

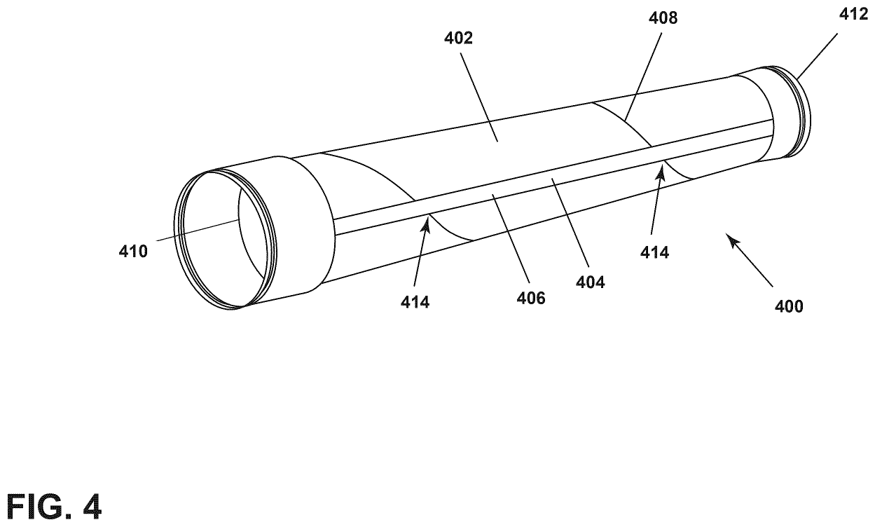

Referring to FIG. 4, a reinforced duct 400 is shown having a duct 402 with a reinforcement structure 404 including a set of longitudinal reinforcement structures 406. The duct 402 can have a seam 408 that extends in a spiral or helical manner. The seam 408 can be formed from a non-linear sheet of material to form the spiral or helical seam 408 by connecting opposing edges to form a cylinder shape. For example, such a sheet can be a non-square parallelogram, where connecting opposing edges defines the cylindrical shape for the duct 402 having the spiraled seam 408. In a non-limiting example, the seam 408 can be any seam that is offset from parallel to the longitudinal extent of the duct 402.

The reinforcement structure 404 extends between a first end 410 and the second end 412. The reinforcement structure 404 can be a longitudinal reinforcement structure, as shown, or can be a cylindrical or circumferential reinforcement structure or any other shape. The reinforcement structure 404 overlaps the seam 408 in at least one location, shown as two overlap locations 414 in FIG. 4.

The spiral shape, or any non-longitudinal shape, for the seam 408 can provide for mitigating thermal expansion for the duct 402. Furthermore, seams in ducts can provide greater opportunity for failure of a duct as compared to areas having no seams. Thermal expansion and contraction of the duct can further exacerbate such opportunity. Therefore, the reinforcement structure 404 overlaps the seam 408 in at least one location 414, which can mitigate failure of the duct 402 at the seam 408 and mitigate failure at the seam 408 resultant of thermal expansion of the duct 402, as well as mitigating the thermal expansion itself.

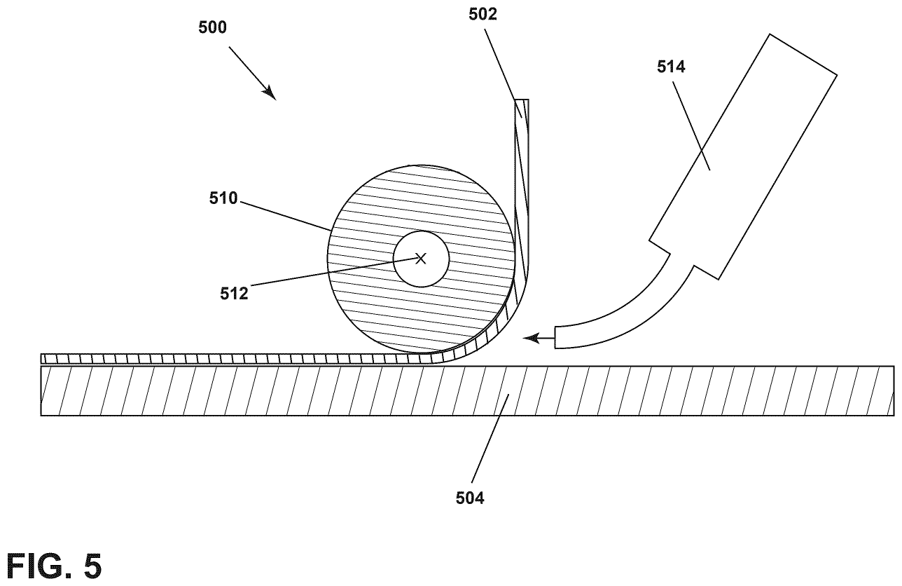

Referring to FIG. 5, system 500 is provided for attaching a reinforcement structure 502 to a duct 504. The reinforcement structure 502 can be a carbon fiber and polyvinylidene fluoride (CF/PVDF) composite material, for example, while any material having a coefficient of thermal expansion that is less than 10% that of PVDF foams, or having an absolute coefficient of thermal expansion of less than 10 in/in° F.*10⁻⁶ is contemplated. The duct 504 can be a foam duct as described herein, such as a cross-linked PVDF foam duct.

A roller 510 rotates about a rotational axis 512 (shown as an “X” in FIG. 5). The roller 510 is rotatable to feed the reinforcement structure 502 along the duct 504. The system 500 and the roller 510 can be positioned and arranged to provide physical compaction and pressure to the reinforcement structure 502 and the duct 504 during attachment of the reinforcement structure to the duct 504 by the roller 510.

A heater 514 positions to heat the PVDF material within the reinforcement structure 502 prior to contact with the duct 504 and compaction by the roller 510. It is contemplated that the fiber material within the reinforcement structure remains unmelted, or has a melting temperature that is greater than that of the temperatures applied by the heater 514. In a non-limiting example, the heater 514 can be a hot air welder, positioned to provide hot air to the reinforcement structure 502. In another non-limiting example, the heater can be an electrical heater that makes contact with the reinforcement structure 502 prior to application to the duct 504.

In operation, the heater 514 heats the reinforcement structure 502 to a melted, liquified, or molten state. In a non-limiting example, for a CF/PVDF composite, the heater 514 can provide heat between temperatures of 400° F.-800° F. where the PVDF resin matrix liquifies, while any temperature suitable to achieve thermal decomposition of the reinforcement structure 502 is contemplated. The reinforcement structure 502 is then contacted with the duct 504 while in the melted, liquified, or molten state, and the roller 510 provides a compaction force to both the reinforcement structure 502 and the duct 504, adhering the reinforcement structure 502 to the duct 504. In a non-limiting example, the duct 504 can be pretreated with a solution, such as a methyl ethyl ketone and polyvinylidene fluoride (MEK/PVDF) solution as discussed herein.

By melting the matrix portion of the reinforcement structure 502, like the PVDF material, prior to attachment to the duct 504, the reinforcement structure 502 can achieve strong bonds with the foam material of the duct 504, and particularly the cross-linked nature of the foam material forming the duct 504. Furthermore, the cross-linked arrangement of the foam material of the duct 504 does not undergo a similar melting, despite receiving some heat during the process, and therefore, mitigates or eliminates the risk of collapse or physical degradation of the duct 504. This results in a strong bond between the duct 504 and the reinforcement structure 502 while minimizing risk to the structural integrity of the underlying duct 504. This permits a duct 504 that has reduced thermal expansion as mitigated by the reinforcement structure 502.

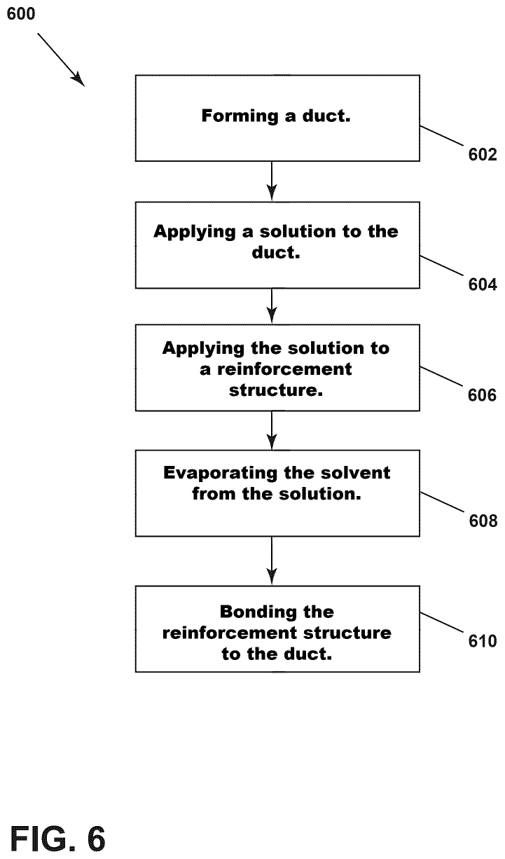

FIG. 6 shows a flow chart depicting a method 600 of forming a duct, such as the ducts 102, 202, 302, 402, 504 of FIGS. 1-5. At 602, the method can include forming the duct, or otherwise providing a formed duct. It is contemplated that, the duct can be provided as a sheet, prior to rolling of the sheet to form the tubular arrangement of the duct. The duct can be made of a foam material, such as a closed-cell PVDF foam. In a non-limiting example, the duct can be made of cross-linked resin grade PVDF. In additional non-limiting examples, the duct can be made of a closed-cell or open-cell material, or can be porous, and can be made of materials like polymers or thermoplastics. In further non-limiting examples, the duct can have a length of between 3 ft to 10 ft, or can have a thickness of greater than or equal to 4 mm and less than or equal to 12 mm.

Additionally, a reinforcement structure can be provided prior to attachment to the duct, such as the reinforcement structures 104, 204, 304, 404, 502 of FIGS. 1-5. It should be understood that the preferred materials for the reinforcement structure, such as carbon fiber or Kevlar, may not or do not form strong chemical bonds with an underlying foam structure of the duct, such as PVDF, and do not bond directly to foam in their virgin state. Therefore, a solution to ensure suitable bonding between the duct and the reinforcement structure is needed. The method 600 provides suitable bonding between the duct and the reinforcement structures.

Furthermore, a solution can be prepared including a solvent and dissolved PVDF powder (or any material which is at least partially forming the duct). The solvent, for example, can be a MEK solvent. The solution, in a non-limiting example, can include 88%-95% MEK, and 5-12% PVDF, with 100% of the solution being a two-component solution of the MEK and PVDF.

At 604, the method 600 can include applying the solution to the duct. After preparation of the solution, the solution may be applied to the duct. For example, when wet bonding, the solution including both the solvent and the duct material is applied to the duct to improve bonding of the reinforcement structure.

At 606, the method 600 can include applying the solution to the reinforcement structure. Such application, or wetting, of the reinforcement structure with the solution can be prior to, during, or after application of the reinforcement structure to the duct in non-limiting examples. Such a wetting can be sufficient to cover, coat, fully wet, or impregnate the reinforcement structure with the solution.

At 608, after application of the solution to the reinforcement structure, the method 600 includes evaporating the solvent from solution provided to one or both of the duct or the reinforcement structure. Evaporation can be facilitated with heat, for example. Evaporation removes the solvent, leaving a film of PVDF throughout and around the reinforcement structure, or encapsulating the reinforcement structure. Such a film can be applied to each of the individual fibers forming the reinforcement structure, and can remain as a film covering the whole of the reinforcement structure, or both. In this way, the reinforcement structure can include or be covered in the same material forming the duct due to application of the solution and removing of the solvent. This provides a bondable material for the reinforcement structure to bond to the duct that matches the material of the duct, providing improved bond between the duct and the reinforcement structure.

At 610, the method 600 can include bonding the reinforcement structure to the duct. The reinforcement structure, now wetted with the solution, or having a film of material the same or similar to that of the underlying duct, can now be cast or bonded to the duct. Specifically, by applying the PVDF-coated reinforcement structure to the duct, applying the solution to the reinforcement structure on the duct, or applying the solution to the duct prior to application of the reinforcement structure, the PVDF-coated reinforcement structure can bond directly to the duct by forming a PVDF-to-PVDF bond, forming a solvent-cast textile for the reinforcement structure which is bonded with the underlying PVDF of the duct. Bonding the PVDF within the reinforcement structure to the PVDF in the duct provides a stronger bond than traditional attachment methods, like adhesives. Such a stronger bond provides improved mitigation of thermal expansion of the duct with the reinforcement structure.

In an alternative, non-limiting example, bonding the reinforcement structure to the duct can utilize or incorporate a thermal bond, utilizing heightened temperatures to bond the reinforcement structure to the duct, or facilitating the solvent-cast bond among the reinforcement structure and the duct. In another alternative, non-limiting example, the bond can be achieved through solvent welding at room temperature.

In another alternative, non-limiting example, bonding the reinforcement structure to the duct can include dry-bonding the reinforcement structure to the duct. Specifically, the reinforcement structure can be laid upon the duct in a desired configuration, such as those shown in FIGS. 1-5, and may be fixed into position mechanically, while attachment without mechanical fixation is contemplated. In non-limiting examples, such fixation can be by way of clamps or other pressure fasteners, or any other fasteners, such as screws. Such mechanical fixing of the reinforcement structure can provide for tensioning the reinforcement structure prior to bonding, for example. The solution can be painted over the reinforcement structure mechanically fixed to the duct, wetting the reinforcement structure. Such a wetting should be sufficient to expose the underlying duct to the solution of MEK and PVDF to activate the surface of the duct for bonding. After painting the solution onto the reinforcement structure, the reinforcement structure is allowed to dry to evaporate the solvent, leaving the PVDF, or other duct material, to bond the reinforcement structure to the underlying duct.

In another alternative, non-limiting example, the duct can be painted or wetted with the solution of MEK and PVDF prior to application of the reinforcement structure, and permitted to dry. The reinforcement structure is applied to the duct at the dried portions. The reinforcement structure can then be further painted or wetted with the solution to thoroughly wet the reinforcement structure with the solution. The solution is then allowed to dry, leaving the PVDF film on the reinforcement structure, which bonds with the PVDF dried onto the underlying duct, which is bonded to the underlying duct itself.

In another alternative, non-limiting example, bonding the reinforcement structure to the duct can include dry-bonding. Thereafter, pressure and/or heat may be applied to the reinforcement structure at the bond-area location in order to achieve a thermal bond between the duct and the reinforcement structure, in addition to the dry-bonded PVDF. In a non-limiting example, the pressure can be between 1-10 psi (pounds per square inch), and the temperature can be between 110° C.-135° C. (degrees Celsius), while additional ranges can be between 110° C.-125° C. or 125° C.-135° C. It should be appreciated that greater or lesser pressures and temperatures are contemplated, and the particular temperatures utilized can be dependent on the type of material utilized in the duct, such as the particular foam PVDF material or other foam material. The pressure can be maintained at the bond-area location, and the temperature is allowed to cool, such as below the forming temperature of the duct or PVDF, permitting the bond to set.

In yet another non-limiting example, bonding the reinforcement structure to the duct can include wet bonding the reinforcement structure to the duct. The duct can be painted or wetted with the solution of MEK and PVDF, or similar solution, at locations where the reinforcement structure will be applied. The reinforcement structure can be wetted with the solution. The wetted reinforcement structure is laid onto the duct at the painted or wetted application locations, and may be mechanically fixed into a desired position. After application and mechanical fixing, the solution is allowed to dry, where the PVDF within the wetted reinforcement structure bonds to the PVDF of the duct during drying.

In yet another non-limiting example, bonding the reinforcement structure to the duct can include wet bonding the reinforcement structure to the duct, where the duct is painted or wetted with the solution of MEK and PVDF at locations where the reinforcement structure will be applied. The reinforcement structure is wetted with the same solution of MEK and PVDF, or with a solvent and material matching the duct. The reinforcement structure is laid onto the duct at the locations that are painted or wetted, and may be mechanically fixed into place. Such mechanical fixation can permit tensioning of the reinforcement structure prior to bonding. The solution of MEK and PVDF is allowed to dry to form a preliminary dry bond between the reinforcement structure and the duct. Thereafter, pressure and heat are applied to the reinforcement structure at the bonding locations. In a non-limiting example, the pressure can be between 1-10 psi (pounds per square inch), and the temperature can be between 110° C.-135° C. (degrees Celsius), while additional ranges can be between 110° C.-125° C. or 125° C.-135° C. It should be appreciated that greater or lesser pressures and temperatures are contemplated, and the particular temperatures utilized can be dependent on the type of material utilized in the duct, such as the particular foam PVDF material or other foam material. The pressure can be maintained at the bond-area location, and the temperature is allowed to cool, such as below the forming temperature of the duct or PVDF, permitting the bond to set.

In yet another non-limiting example, bonding the reinforcement structure to the duct can include solvent-cast bonding to the duct. The reinforcement structure is wetted with the solution of MEK and PVDF and permitted to dry, yielding a solvent-cast textile as the reinforcement structure, which includes the original reinforcement materials impregnated with, covered, and/or encapsulated in the PVDF material. Such a reinforcement structure can be applied to textile blanks, which are precut to the proper dimensions for immediate bonding to the duct after the solvent-cast textile is dried. In another example, the reinforcement structure need not be precut, and raw textiles, such as sheets, can be cut after the solvent-cast bonding to desired dimensions for the particular duct. Thereafter, the duct can be painted or wetted with additional solution of MEK and PVDF at locations where the reinforcement structure will be applied. The reinforcement structure is applied to the duct at the wetted locations, which may or may not be mechanically fixed thereto. Additional solution may be applied to the reinforcement structure after application to the duct. The duct is allowed to dry, bonding the prepared reinforcement structure to the duct. In another example, it is contemplated that additional pressure and heat may be applied to further establish the bond. In a non-limiting example, the pressure can be between 1-10 psi (pounds per square inch), and the temperature can be between 110° C.-135° C. (degrees Celsius), while additional ranges can be between 110° C.-125° C. or 125° C.-135° C. It should be appreciated that greater or lesser pressures and temperatures are contemplated, and the particular temperatures utilized can be dependent on the type of material utilized in the duct, such as the particular foam PVDF material or other foam material. The pressure can be maintained at the bond-area location, and the temperature is allowed to cool, such as below the forming temperature of the duct or PVDF, permitting the bond to set.

Bonding of the reinforcement structure can be done discretely, bonding each individual portion of a whole reinforcement structure, such the longitudinal portion or the circumferential portion thereof. Alternatively, bonding can be done for the entire reinforcement structure, including two or more longitudinal or circumferential portions, which are bonded to the duct simultaneously or during the same process. Additionally, it is contemplated that such bonding can be done prior to the formation of the duct, such as bonding the reinforcement structures to a sheet, and folding the sheet end-to-end to create the cylindrical duct with the reinforcement structures already integrated into the duct.

Bonding the reinforcement structure to the duct in the manner described with respect to the method 600 results in an improved bond between the duct and the reinforcement structure. Such an improved bond improves the mitigation of thermal expansion or contraction of the duct provided by the reinforcement structure. Additionally, the method 600 provides for bonding the reinforcement structure to the duct without physical degradation to the duct.

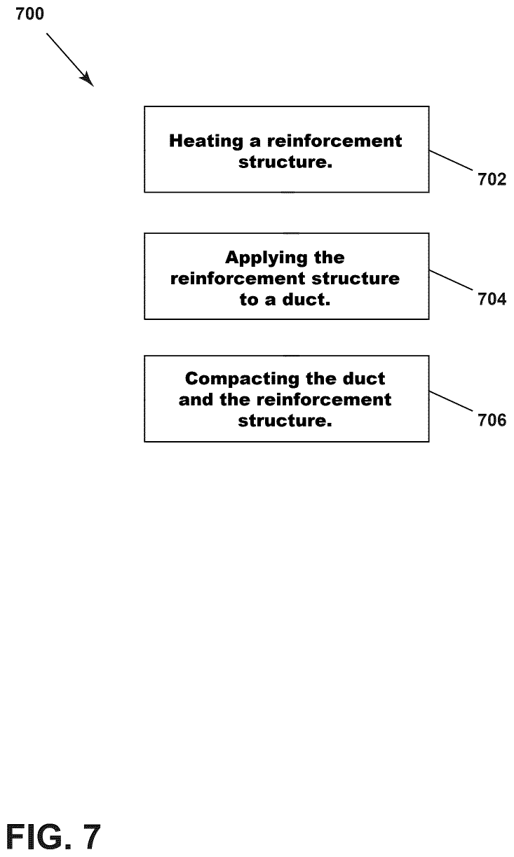

FIG. 7 shows a flow chart depicting a method 700 of forming a reinforced duct, such as the ducts 102, 202, 302, 402, 504 of FIGS. 1-5. At 702, the method can include heating a reinforcement structure, such as the reinforcement structures 104, 204, 304, 404, 502 of FIGS. 1-5, and utilizing the heater 514 of FIG. 5. Heating can include heating the reinforcement structure such that the reinforcement structure, or a portion or surface thereof, melts, is liquified, or becomes molten. For a CF/PVDF composite, the reinforcement structure can be heated to temperatures between 400° F.-800° F., where the PVDF resin matrix liquifies, while any temperature suitable to achieve melting of the matrix material of the composite reinforcement structure is contemplated.

The duct can be made of a foam material, such as a closed-cell PVDF foam. In a non-limiting example, the duct can be made of cross-linked resin grade PVDF. In additional non-limiting examples, the duct can be made of a closed-cell or open-cell material, or can be porous, and can be made of materials like polymers or thermoplastics. In further non-limiting examples, the duct can have a length of between 3 ft to 10 ft, or can have a thickness of greater than or equal to 4 mm and less than or equal to 12 mm. In a non-limiting example, the duct may be at least partially heated, or the surface thereof, to achieve a stronger bond during application of the reinforcement structure to the duct. The cross-linked nature of the duct can prevent or mitigate melting or physical degradation of the duct. The PVDF present in the reinforcement structure does not have a similar cross-linked nature, which prevents the duct from melting while the reinforcement structure is being applied.

At 704, the method 700 can include applying the reinforcement structure to the duct. Such an application can be done with a roller, like the roller 510 utilized within the system 500 of FIG. 5. In a non-limiting example, the duct may be treated with a solution, like a solution of a solvent and PVDF, or other material matching that of the duct. Such a treatment can further improve the bond between the reinforcement structure and the duct. Other applications are contemplated, including laying the reinforcement structure over the duct or mechanically fixing the reinforcement structure to the duct, in non-limiting examples. As the reinforcement structure, heated at 702, begins to cool, the reinforcement structure solidifies, forming a strong bond with the duct, particularly in the case of cross-linked foams. Cross-linked foam material does not undergo traditional thermal phase changes like ‘melting’ in the conventional sense, and therefore, the duct can remain resistant to collapse and physical degradation or other deformation during the formation process.

At 706, the method 700 can include optionally compacting the duct and the reinforcement structure. For example, as shown in FIG. 5, the roller is rotated to both apply the reinforcement structure to the duct, (like at 704), and to compact the duct and reinforcement structure. Physical compaction can further enhance the bond between the reinforcement structure and the duct.

It should be appreciated that a reinforcement structure as discussed herein mitigates, minimizes, reduces, or prevents thermal expansion or contraction in a direction longitudinally along a duct. Such a limit can be no more than 0.1 inches or 0.2 inches expansion or contraction longitudinally along the duct, such as between a -3-foot to 10-foot length for the duct. Additionally, a circumferential reinforcement structure prevents, limits, or minimizes circumferential expansion or contraction of the duct, such as in direction perpendicular to the longitudinal extent of the duct. Additionally, the methods of forming the duct with the reinforcement structure can be seamless, which requires no additional reinforcement or protection at seams, which may otherwise provide potential areas for failure for reinforcements.

Additionally, it should be appreciated that non-linear ducts, such as those with curves, turns, or bends, can include different directionalities of expansion or contraction, due to local orientations. The reinforcement structure as described herein provides for minimizing, reducing, or eliminating thermal expansion in discrete directionalities, by using local arrangements of the longitudinal portion or the circumferential portion, permitting large lengths for the duct with complex geometries capable of reduced, minimized, or eliminated thermal expansion.

To the extent one or more structures, elements, or steps provided herein can be known in the art, it should be appreciated that the present disclosure can include combinations of structures not previously known to combine, at least for reasons based in part on conflicting benefits versus losses, desired modes of operation, or other forms of teaching away in the art.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the disclosure are provided by the subject matter of the following clauses:

A method of forming a reinforced duct, the method comprising: applying a solution to a reinforcement structure; applying the reinforcement structure to a duct; and evaporating a solvent from the solution applied to the reinforcement structure to bond the reinforcement structure to the duct.

The method of any preceding clause, wherein the duct is a foam duct.

The method of any preceding clause, wherein the duct is made from PVDF.

The method of any preceding clause, further comprising applying at least one of heat or pressure to the reinforcement structure.

The method of any preceding clause, wherein the applied heat or pressure achieves a thermal bond between the reinforcement structure and the duct.

The method of any preceding clause, further comprising applying the solution to the duct prior to applying the reinforcement structure to the duct.

The method of any preceding clause, further comprising allowing the solution applied to the duct to dry prior to application of the reinforcement structure to the duct.

The method of any preceding clause, wherein the duct is dry prior to application of the reinforcement structure.

The method of any preceding clause, further comprising evaporating the solvent from the solution applied to the reinforcement structure prior to applying the reinforcement structure to the duct, and further comprising applying the solution to the reinforcement structure after the reinforcement structure has been applied to the duct.

The method of any preceding clause, wherein the duct further comprises a seam, and wherein the reinforcement structure is applied to the duct to overlay the seam on at least one location.

The method of any preceding clause, wherein the seam is in a spiral arrangement about the duct.

The method of any preceding clause, wherein the reinforcement structure overlays the seam on at least two locations.

The method of any preceding clause, further comprising mechanically fixing the reinforcement structure to the duct.

The method of any preceding clause, wherein mechanically fixing the reinforcement structure occurs prior to evaporation of the solvent to bond the reinforcement structure to the duct.

The method of any preceding clause, further comprising removing the mechanical fixture after the reinforcement structure is bonded to the duct.

The method of any preceding clause, further comprising tensioning the reinforcement structure prior to mechanically fixing the reinforcement structure.

The method of any preceding clause, wherein the reinforcement structure comprises carbon fiber or Kevlar.

The method of any preceding clause, wherein the reinforcement structure is arranged as at least one of a set of longitudinal reinforcement structures or a set of circumferential reinforcement structures.

The method of any preceding clause, wherein the reinforcement structure is arranged as a combination of both the set of longitudinal reinforcement structures and the set of circumferential reinforcement structures.

The method of any preceding clause, wherein the solution comprises a same material as the duct mixed with the solvent.

The method of any preceding clause, wherein the material is PVDF.

The method of any preceding clause, wherein the solvent is MEK.

The method of any preceding clause, wherein the solution comprises 88%-95% MEK and 5%-12% PVDF.

The method of any preceding clause, wherein the applying the solution to the reinforcement structure further comprises forming a solvent-cast textile as the reinforcement structure prior to applying the reinforcement structure to the duct.

The method of any preceding clause, wherein the solvent-cast textile is wet bonded to the duct.

The method of any preceding clause, further comprising coupling end caps to opposing ends of the duct.

The method of any preceding clause, wherein the reinforcement structure extends fully between opposing ends of the duct.

The method of any preceding clause, wherein the reinforcement structure is applied to the duct prior to application of the solution to the reinforcement structure.

The method of any preceding clause, wherein the reinforcement structure is sufficiently wetted with the solution to activate an exterior surface of the duct for bonding to the reinforcement structure.

The method of any preceding clause, wherein evaporating the solvent from the solution provides a film of material throughout the reinforcement structure.

The method of any preceding clause, wherein the film of material is a same material as the duct.

The method of any preceding clause, wherein the duct is unrolled, and the method further comprises rolling the duct to form a cylindrical shape for the duct.

The method of any preceding clause, wherein the duct comprises cross-linked PVDF.

A method of forming a reinforced duct, the method comprising: heating a reinforcement structure, formed as a composite comprising a reinforcement material and a thermoplastic material, to melt the thermoplastic material; and applying the heated reinforcement structure to a foam duct comprising the same thermoplastic material as the reinforcement structure; wherein the thermoplastic material melted in the reinforcement structure bonds to the same thermoplastic material in the foam duct.

The method of any preceding clause, wherein the foam duct is made from PVDF.

The method of any preceding clause, further comprising applying at least one of heat or pressure to the reinforcement structure after applying the reinforcement structure to the foam duct.

The method of any preceding clause, wherein the foam duct further comprises a seam, and wherein the reinforcement structure is applied to the foam duct to overlay the seam on at least one location.

The method of any preceding clause, wherein the seam is in a spiral arrangement about the foam duct.

The method of any preceding clause, wherein the reinforcement structure overlays the seam on at least two locations.

The method of any preceding clause, further comprising mechanically fixing the reinforcement structure to the foam duct.

The method of any preceding clause, further comprising removing the mechanical fixture after the reinforcement structure is bonded to the foam duct.

The method of any preceding clause, wherein the reinforcement structure comprises fibers encapsulated in PVDF.

The method of any preceding clause, wherein the reinforcement structure comprises carbon fiber or Kevlar fiber.

The method of any preceding clause, wherein the reinforcement structure is arranged as at least one of a set of longitudinal reinforcement structures or a set of circumferential reinforcement structures.

The method of any preceding clause, wherein the reinforcement structure is arranged as a combination of both the set of longitudinal reinforcement structures and the set of circumferential reinforcement structures.

The method of any preceding clause, further comprising coupling end caps to opposing ends of the foam duct.

The method of any preceding clause, wherein the reinforcement structure extends fully between opposing ends of the foam duct.

The method of any preceding clause, wherein bonding the reinforcement structure to the foam duct comprises a thermal weld.

The method of any preceding clause, wherein heating the reinforcement structure further comprises liquefying the reinforcement structure or a portion thereof.

The method of any preceding clause, wherein the foam duct is unrolled, and the method further comprises rolling the foam duct to form a cylindrical shape for the foam duct.

The method of any preceding clause, wherein applying the heated reinforcement structure to the foam duct further comprises rolling the heated reinforcement structure onto the foam duct with a roller.

The method of any preceding clause, wherein the roller further compacts the foam duct and the reinforcement structure as it rolls the heated reinforcement structure onto the foam duct.

The method of any preceding clause, wherein the foam duct comprises cross-linked foam PVDF.

The method of any preceding clause, further comprising applying the thermoplastic material to the reinforcement material to form the reinforcement structure.

The method of any preceding clause, further comprising applying a solution of the thermoplastic material and a solvent to the foam duct.

The method of any preceding clause, further comprising applying the solution prior to application of the reinforcement structure.

The method of any preceding clause, further comprising applying a solution of the thermoplastic material and a solvent to the reinforcement structure after application of the reinforcement structure to the foam duct.

An assembly for forming a reinforced duct, the assembly comprising: a foam duct having an exterior surface; a roller; a heater; and a reinforcement structure positioned to be heated by the heater and applied to the foam duct by the roller.

The assembly of any preceding clause, wherein the roller is positioned to compact the reinforcement structure against the foam duct.

The assembly of any preceding clause, wherein the heater is a hot air welder.

The assembly of any preceding clause, wherein the foam duct is made of PVDF.

The assembly of any preceding clause, wherein the duct is a cross-linked foam material.

The assembly of any preceding clause, wherein the reinforcement structure is a composite including PVDF.

The assembly of any preceding clause, wherein the composite is a carbon fiber and PVDF composite.

The assembly of any preceding clause, wherein the reinforcement structure comprises the same material as the foam duct.

The assembly of any preceding clause, wherein the reinforcement structure is arranged as at least one of a set of longitudinal reinforcement structures or a set of circumferential reinforcement structures.

The assembly of any preceding clause, wherein the reinforcement structure is arranged as a combination of both the set of longitudinal reinforcement structures and the set of circumferential reinforcement structures.

The assembly of any preceding clause, wherein the heater is configured to heat the reinforcement structure to between 400° F. and 800° F.

What is claimed is:

1. A method of forming a reinforced duct, the method comprising:
heating a reinforcement structure, formed as a composite comprising a reinforcement material and a thermoplastic material, to melt the thermoplastic material; and
applying the heated reinforcement structure to a foam duct comprising the same thermoplastic material as the reinforcement structure;
wherein the thermoplastic material melted in the reinforcement structure bonds to the same thermoplastic material in the foam duct.

2. The method of claim 1, further comprising cooling the heated reinforcement structure to yield the foam duct with the reinforcement structure bonded to the foam duct.

3. The method of claim 1, wherein the foam duct is a cross-linked foam PVDF duct.

4. The method of claim 1, wherein the thermoplastic material is PVDF.

5. The method of claim 4, wherein the reinforcement material is one of carbon fiber or Kevlar fiber.

6. The method of claim 1, further comprising applying at least one of heat or pressure to the reinforcement structure after applying the reinforcement structure to the foam duct.

7. The method of claim 1, wherein the foam duct further comprises a seam, and wherein the reinforcement structure is applied to the foam duct to overlay the seam on at least one location.

8. The method of claim 7, wherein the seam is in a spiral arrangement about the foam duct.

9. The method of claim 1, further comprising mechanically fixing the reinforcement structure to the foam duct.

10. The method of claim 9, further comprising removing the mechanical fixture after the reinforcement structure is applied to the foam duct.

11. The method of claim 1, wherein the reinforcement structure is arranged as at least one of a set of longitudinal reinforcement structures or a set of circumferential reinforcement structures.

12. The method of claim 11, wherein the reinforcement structure is arranged as a combination of both the set of longitudinal reinforcement structures and the set of circumferential reinforcement structures.

13. The method of claim 1, wherein the reinforcement structure extends fully between opposing ends of the foam duct.

14. The method of claim 1, wherein the foam duct is unrolled, and the method further comprises rolling the foam duct to form a cylindrical shape for the foam duct.

15. The method of claim 1, wherein applying the heated reinforcement structure to the foam duct further comprises rolling the heated reinforcement structure onto the foam duct with a roller.

16. The method of claim 15, wherein the roller further compacts the foam duct and the reinforcement structure as it rolls the heated reinforcement structure onto the foam duct.

17. The method of claim 1, further comprising applying the thermoplastic material to the reinforcement material to form the reinforcement structure.

18. The method of claim 1, further comprising applying a solution of the thermoplastic material and a solvent to the foam duct.

19. The method of claim 18, further comprising applying the solution prior to application of the reinforcement structure.

20. The method of claim 1, further comprising applying a solution of the thermoplastic material and a solvent to the reinforcement structure after application of the reinforcement structure to the foam duct.
